(19) United States
(12) Patent Application Publication
(10) Pub. No.: US 2026/0012503 A1
(43) Pub. Date: Jan. 8, 2026

(54) LOAD BALANCING METHOD BASED ON CONTAINERIZED MICROSERVICE ARCHITECTURE, STORAGE MEDIUM AND ELECTRONIC DEVICE

(71) Applicant: Beijing Volcano Engine Technology Co., Ltd., Haidian District (CN)

(72) Inventors: Wei QUAN, Beijing (CN); Jun DONG, Beijing (CN); Rui ZHANG, Beijing (CN); Rui CAO, Beijing (CN); Junming CHEN, Beijing (CN)

(21) Appl. No.: 19/176,448

(22) Filed: Apr. 11, 2025

(30) Foreign Application Priority Data
Jul. 3, 2024 (CN) 202410889797.9

(51) Int. Cl. H04L 67/1014; H04L 12/46; H04L 61/2503; H04L 67/56

(52) U.S. Cl. CPC H04L 67/1014; H04L 12/4633; H04L 61/2503; H04L 67/56

(57) ABSTRACT

A load balancing method based on a containerized microservice architecture, a storage medium and an electronic device are provided. The load balancing method includes: intercepting a first message initiated by a source container of a client that accesses a destination service in a microservice cluster, encapsulating the first message using a tunnel, and then sending the first message to a centralized load balancing component; distributing the first message to a destination container of the destination service such that the destination container generates a first response message for the first message; and receiving the first response message, and generating a first connection tracking record of a communication between the source container and the destination container based on the first response message.

### CROSS-REFERENCE TO RELATED APPLICATION(S)

This application claims the priority to and benefits of the Chinese Patent Application, No. 202410889797.9, which was filed on Jul. 3, 2024, which is hereby incorporated by reference in its entirety.

### TECHNICAL FIELD

The present disclosure relates to the field of computer technology, and in particular, to a load balancing method based on a containerized microservice architecture, a storage medium, and an electronic device.

### BACKGROUND

The two most important constituent parts of a microservice architecture are service discovery and load sharing. For example, in Kubernetes (a container cluster management system) microservice architecture, “Service” is usually utilized to provide a unified service entry for a set of container applications having the same function, and provide load sharing to distribute a request to a back-end container.

In the related art, each node acquires and delivers service configuration information in an API (Application Programming Interface) Server (a gateway in a Kubernetes cluster) based on its own proxy service, and then distributes a message based on the service configuration information. When there are a large number of nodes in the Kubernetes cluster, the API Server is under a high load and thus is slow in the distribution of the service configuration information.

### SUMMARY

Embodiments of the present disclosure provide a load balancing method based on a containerized microservice architecture, a storage medium, and an electronic device

In the first aspect, the embodiments of the present disclosure provide a load balancing method based on a containerized microservice architecture, the load balancing method comprising:
intercepting, by a proxy component deployed on a client side, a first message initiated by a source container of a client that accesses a destination service in a microservice cluster, encapsulating the first message using a tunnel, and then sending the first message to a centralized load balancing component, wherein the centralized load balancing component is configured to distribute a first message for each container of the client that accesses each service in the microservice cluster, and forward the message to a destination container of a destination service through the tunnel;
distributing, by the centralized load balancing component, the first message to a destination container of the destination service such that the destination container generates a first response message for the first message; and
receiving, by the proxy component on the client side, the first response message, and generating a first connection tracking record of a communication between the source container and the destination container based on the first response message, wherein the first connection tracking record is configured to record a network address translation relationship between the source container and the destination container such that a traffic direct communication is performed between the source container and the destination container based on the network address translation relationship after a connection of the first message is established.

In the second aspect, the embodiments of the present disclosure provide a non-transitory computer-readable storage medium, storing a computer program which, when executed by a processing apparatus, implements the above-mentioned load balancing method based on a containerized microservice architecture.

In the third aspect, the embodiments of the present disclosure provide an electronic device, comprising:
a storage apparatus, configured to store a computer program; and
a processing apparatus, configured to execute the computer program in the storage apparatus to implement the above-mentioned load balancing method based on a containerized microservice architecture.

With the above technical solution, the first message initiated by the source container that accesses the destination service is distributed by the centralized load balancing component to the destination container of the destination service, thereby realizing dynamic distribution of the first message. The first response message generated by the destination container for the first message is then received by the proxy component on the client side, and the first connection tracking record of the communication between the source container and the destination container is generated based on the first response message, such that traffic direct communication is performed between the source container and the destination container based on the network address translation relationship after the connection of the first message is established. In this way, the service configuration information in the API Server is obtained by the centralized load balancing component so that the distribution pressure of the service configuration information can be reduced. Moreover, in the manner of one-time dynamic distribution and subsequent direct communication, the forwarding pressure of the centralized load balancing component can also be reduced. This manner shortens the communication link and has the advantages of high throughput and low delay.

Other features and advantages of the present disclosure will be described in detail in the following detailed description.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a process schematic diagram of a load sharing according to an exemplary embodiment of the present disclosure;

FIG. 2 is a process schematic diagram of a distributed load sharing according to an exemplary embodiment of the present disclosure;

FIG. 3 is a process schematic diagram of a centralized load sharing according to an exemplary embodiment of the present disclosure;

FIG. 4 is a flowchart of a load balancing method based on a containerized microservice architecture according to an exemplary embodiment of the present disclosure;

FIG. 5 is a process schematic diagram of a load balancing method based on a containerized microservice architecture according to an exemplary embodiment of the present disclosure;

FIG. 6 is a schematic diagram of a processing flow of a load balancer according to an exemplary embodiment of the present disclosure;

FIG. 7 is a schematic diagram of a processing flow of a proxy component according to an exemplary embodiment of the present disclosure;

FIG. 8 is a schematic diagram of a processing flow of a proxy component according to an exemplary embodiment of the present disclosure;

FIG. 9 is a schematic diagram of a load balancing system based on a containerized microservice architecture according to an exemplary embodiment of the present disclosure;

FIG. 10 is a structural block diagram of a load balancing apparatus based on a containerized microservice architecture according to an exemplary embodiment of the present disclosure; and

FIG. 11 is a structural schematic diagram of an electronic device according to an exemplary embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that “one” and “more” mentioned in the present disclosure are schematic rather than restrictive, and those skilled in the art should understand that unless otherwise explicitly stated in the context, it should be understood as “one or more”.

The names of the messages or information exchanged among multiple apparatuses in the embodiments of the present disclosure are only for illustrative purposes and are not intended to limit the scope of these messages or information.

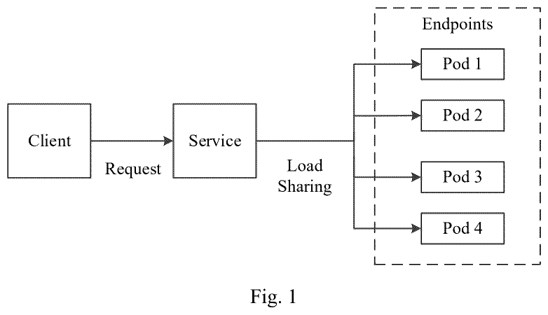

Taking a Kubernetes system as an example, with reference to FIG. 1, a client sends a request message to a destination service (“Service”) in a microservice cluster, and the Service provides load sharing to distribute the request message to a back-end container (“Pod”) which is also referred to as an endpoint (“Endpoint”). The Service needs to perceive creation and deletion of the Service and the back-end Pod in order to maintain a correspondence between Service Cluster IP (a service address) and Endpoint Pod IP (an endpoint container address), i.e., service configuration information, and can provide load sharing according to the service configuration information to realize traffic distribution.

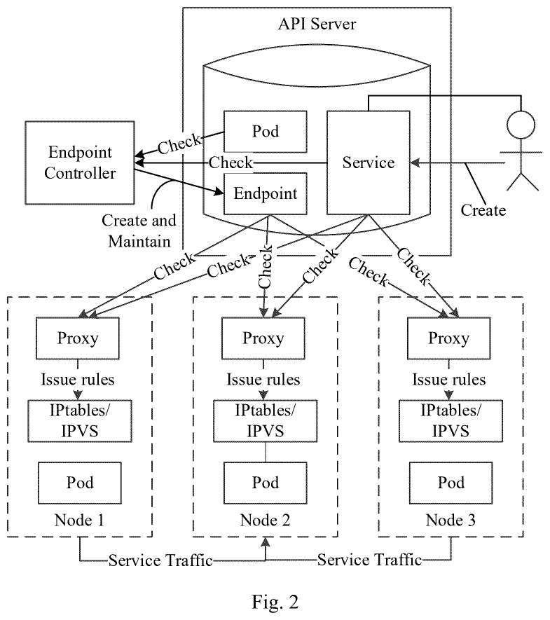

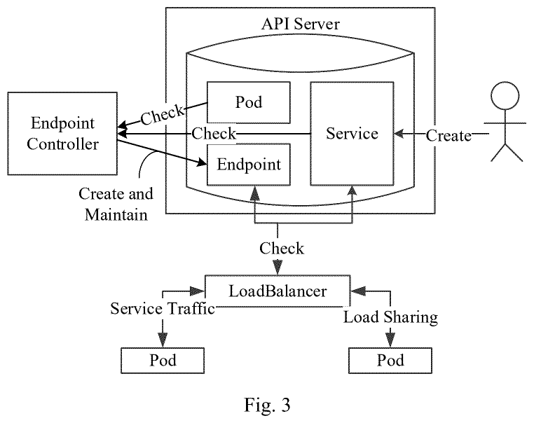

With reference to FIG. 2 or FIG. 3, the Service may be directly created by a user. The Endpoint may be automatically created by the Kubernetes system according to a user configuration in the Service. An endpoint controller (“Endpoint Controller”) is configured to create and maintain the Endpoint, and the Endpoint is configured to store Pod information.

A related art provides a distributed traffic distribution manner, as shown in FIG. 2, in which the creation of the Service and the updating of the Endpoint in a Kubernetes API Server are perceived by a proxy (“Proxy”) component deployed on each node (“Node”), and dynamically delivered to a kernel forwarding rule of the node. The traffic of the Pod of the client that accesses the Service is directly subjected to network address translation by the Proxy component to realize access to the Pod of the Endpoint, and the Proxy supports a load sharing mode of IPtables (a tool for configuring a network packet filtering rule provided by the kernel) and IPVS (IP Virtual Server, which is a load balancer).

The above manner needs to perceive changes of all Services and associated Endpoints in the API Server by replying on the Proxy component deployed in each node, i.e., update and maintain the service configuration information. When a node in the cluster undergoes capacity expansion, the number of Proxy components may increase, and the number of connections established with the API Server may also increase. Moreover, when the scale of the cluster increases, the number of Pods and the number of Services may often increase accordingly, resulting in that the data volume to be transmitted between each node and the API Server grows exponentially. That is, a high load leads to slow delivery of the service configuration information.

The related art provides a centralized traffic distribution manner, as shown in FIG. 3, in which the traffic distribution of the Kubernetes system can be realized by using an external centralized load balancing component (“LoadBalancer”). The principle of the distribution is that: all the Service traffic is guided to the unified LoadBalancer, and the changes of a Service and an associated Endpoint are perceived by the LoadBalancer. Therefore, the related service configuration information does not need to be distributed on each node, and the traffic of the Pod of the client that accesses the Service can be directly distributed in the LoadBalancer.

In the above manner, the centralized load balancing component is used as a center node so that the number of components need to interact with the API Server can be reduced. However, all the traffic that access the Service is distributed by the LoadBalancer. Compared with the distributed traffic distribution manner, there is a longer network communication path, which may lead to a longer network delay. Moreover, the LoadBalancer needs to process all messages of accessing the Service in the cluster, with a low request throughput.

In view of the above, the present disclosure provides a load balancing method based on a containerized microservice architecture, a storage medium and an electronic device, in order to solve the above-mentioned technical problems. It should be noted that the load balancing method provided by embodiments of the present disclosure may be applied to the containerized microservice architecture, e.g., to a Kubernetes system or to a case of a container cloud orchestration engine other than the Kubernetes system, which will not be limited here in the present disclosure.

The embodiments of the present disclosure are further explained and described below with reference to the drawings.

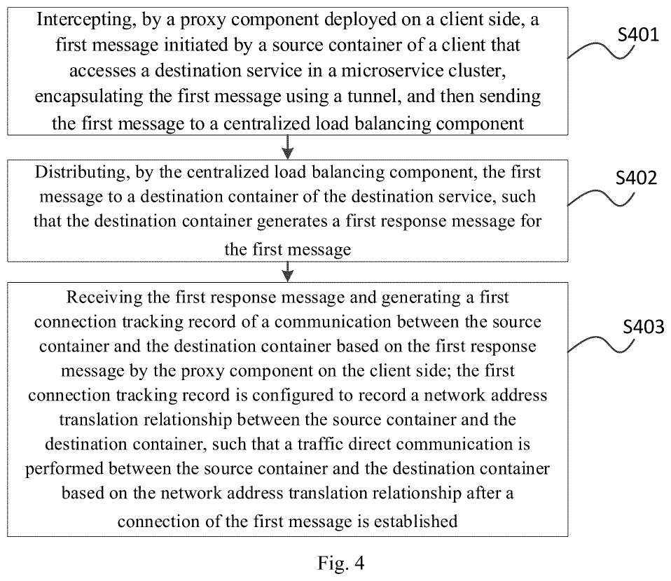

FIG. 4 is a flowchart of a load balancing method based on a containerized microservice architecture according to an exemplary embodiment of the present disclosure. With reference to FIG. 4, the load balancing method includes the following steps.

S401: intercepting, by a proxy component deployed on a client side, a first message initiated by a source container of a client that accesses a destination service in a microservice cluster, encapsulating the first message using a tunnel, and then sending the first message to a centralized load balancing component.

The centralized load balancing component is configured to distribute the first message for each container of the client that accesses each service in the microservice cluster, and forward the first message to a destination container of a destination service using a tunnel.

S402: distributing, by the centralized load balancing component, the first message to a destination container of the destination service, such that the destination container generates a first response message for the first message.

S403: receiving the first response message and generating a first connection tracking record of a communication between the source container and the destination container based on the first response message by the proxy component on the client side; the first connection tracking record is configured to record a network address translation relationship between the source container and the destination container, such that a traffic direct communication is performed between the source container and the destination container based on the network address translation relationship after a connection of the first message is established.

It should be noted that addresses involved in the present disclosure include an IP address and a port number. The IP address includes, but is not limited to, an IPV4 address defined in RFC 791 and an IPV6 address defined in RFC 2460. The port number includes, but is not limited to, a TCP Port defined in RFC 9293 and a UDP Port defined in RFC 786.

With the above technical solution, the first message initiated by the source container that accesses the destination service is distributed by the centralized load balancing component to the destination container of the destination service, thereby realizing dynamic distribution of the first message. The first response message generated by the destination container for the first message is then received by the proxy component on the client side, and the first connection tracking record of the communication between the source container and the destination container is generated based on the first response message, such that traffic direct communication is performed between the source container and the destination container based on the network address translation relationship after the connection of the first message is established. In this way, the service configuration information in the API Server is obtained by the centralized load balancing component so that the distribution pressure of the service configuration information can be reduced. Moreover, in the manner of one-time dynamic distribution and subsequent direct communication, the forwarding pressure of the centralized load balancing component can also be reduced. Compared with the centralized traffic distribution manner, this manner shortens the communication link and has the advantages of high throughput and low delay.

It should be noted that one Proxy component is usually deployed on one node and may include a plurality of Pods, and the Pods of the same node may belong to a plurality of Services or not belong to any Service, which will not be limited here in the present disclosure. When a Pod accesses other Services, the Pod may serve as a Pod on the client (“Client”) side. When the Pod serves as a Pod which is accessed, the Pod serves as a Pod on the Service side.

In a possible implementation, the intercepting, by a proxy component deployed on a client side, a first message initiated by a source container of a client that accesses a destination service in a microservice cluster, encapsulating the first message using a tunnel, and then sending the first message to a centralized load balancing component includes: intercepting a request message initiated by the source container of the client that accesses the destination service in the microservice cluster, and matching addresses of the source container and the destination service with existing first connection tracking records, by the proxy component deployed on the client side; in response to that the first connection tracking record corresponding to the addresses of the source container and the destination service is not matched, determining the request message as the first message, encapsulating the first message using the tunnel, and then sending the first message to the centralized load balancing component.

Alternatively, in response to that a target first connection tracking record corresponding to the addresses of the source container and the destination service is matched, a destination address of the request message is translated to an address of a destination container in the target first connection tracking record, and the request message is sent to the destination container.

Exemplarily, the request message initiated by the source container of the client that accesses the destination service in the microservice cluster is intercepted by the proxy component deployed on the client side. In response to that the first connection tracking record corresponding to the addresses of the source container and the destination service is not matched, it indicates that the Client Pod sends the request message to the Service for the first time, and the first message may be encapsulated using a tunnel protocol and then forwarded to the LoadBalancer through the tunnel. Thus, dynamic distribution of the first message is realized. Alternatively, in response to that the target first connection tracking record corresponding to the addresses of the source container and the destination service is matched, the destination address of the request message may be translated to the address of the destination container in the target first connection tracking record, and the request message may be sent to the destination container based on the address of the destination container. Thus, the traffic direct communication may be achieved between the source container and the destination container.

In a possible implementation, the distributing, by the centralized load balancing component, the first message to a destination container of the destination service includes: determining, by the centralized load balancing component, the destination container of the destination service corresponding to the first message according to service configuration information, and distributing the first message to the destination container, wherein the service configuration information is issued by the microservice cluster and used to instruct a configuration rule for the centralized load balancing component distributing a message.

Exemplarily, the LoadBalancer is responsible for perceiving the changes of the Service and the Endpoint that is associated with the Service. That is, the centralized load balancing component interacts with the microservice cluster to acquire the service configuration information issued by the microservice cluster. Next, the LoadBalancer determines a plurality of containers corresponding to the destination service, according to the address of the destination service corresponding to the first message and the service configuration information, and allocate one of the plurality of containers as the destination container, and then distribute the first message to the destination container, thereby realizing dynamic distribution of the first message. Moreover, the service configuration information is acquired by the LoadBalancer, so that the distribution pressure of the service configuration information can be reduced.

In a possible implementation, the first response message carries an address of the source container, an address of the destination service, and an address of the destination container; and the generating a first connection tracking record of a communication between the source container and the destination container based on the first response message includes: generating a first connection tracking record of a communication between the source container and the destination container based on the address of the source container, the address of the destination service, and the address of the destination container; the first connection tracking record is configured to instruct that the destination address of a request message initiated by the source container that accesses the destination service is changed from the address of the destination service to the address of the destination container, and the source address of a response message returned by the destination container to the source container is changed from the address of the destination container to the address of the destination service.

Exemplarily, after receiving the first response message, the proxy component on the client side generates the first connection tracking record based on the address of the source container, the address of the destination service, and the address of the destination container. In this way, when the proxy component on the client side subsequently intercepts the request message sent by the source container to the destination service, the destination address of the request message is changed from the address of the destination service to the address of the destination container, and then the request message may be directly sent to the destination container. Thus, the traffic direct communication can be achieved between the source container and the destination container.

Alternatively, when the proxy component on the client side subsequently intercepts the response message returned by the destination container to the source container, the source address of the response message is changed from the address of the destination container to the address of the destination service. In the case of the source container not perceiving the particular destination container, the traffic direct communication can be also achieved between the source container and the destination container.

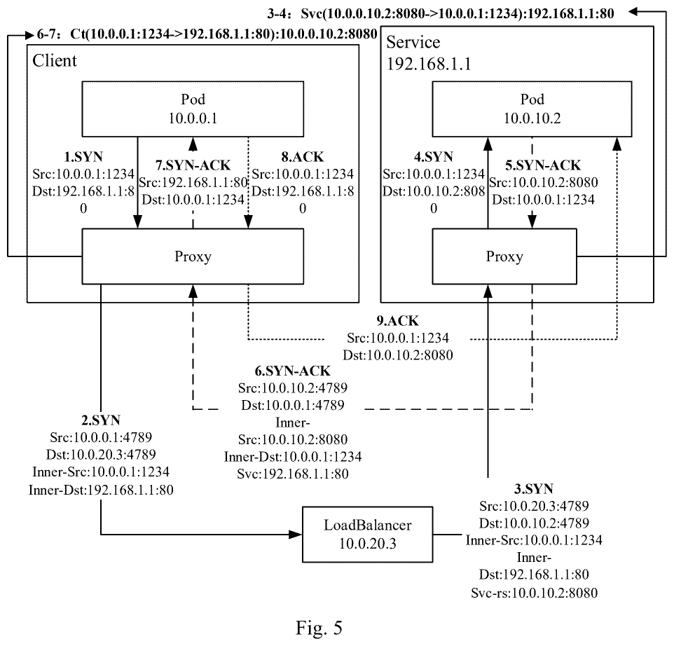

For ease of description, the embodiments are described below by taking transmission control protocol (TCP) traffic as an example. With reference to FIG. 5, a particular embodiment is described by taking the following as an example: the address of the Client Pod (i.e., the source container) is 10.0.0.1; the IP:Port (IP address:port number) of the Service (i.e., the destination service) that is accessed using the TCP is 192.168.1.1:80; the address of the Endpoint Pod (i.e., the destination container) is 10.0.10.2; and the address of the LoadBalancer is 10.0.20.3.

In a possible implementation, the first message carries the address of the source container and the address of the destination service; and the encapsulating the first message using a tunnel and then sending the first message to a centralized load balancing component includes: encapsulating, by the proxy component on the client side, the first message using the tunnel to acquire a first encapsulated message, and sending the first encapsulated message to a centralized load balancing component, wherein a destination address of the first encapsulated message is an address of the centralized load balancing component. The distributing, by the centralized load balancing component, the first message to a destination container of the destination service includes: decapsulating the first encapsulated message by the centralized load balancing component to acquire the first message, encapsulating the address of the destination container and the first message using the tunnel to acquire a second encapsulated message, and distributing the second encapsulated message to a proxy component on the destination container side, a destination address of the second encapsulated message is an address of the proxy component on the destination container side; decapsulating the second encapsulated message by the proxy component on the destination container side to acquire the first message and the address of the destination container, and after replacing the address of the destination service in the first message with the address of the destination container, sending the first message that is acquired after the replacement to the destination container.

Exemplarily, in step 1 as shown in FIG. 5, when the Client Pod accesses the Service, a first Synchronize Sequence Numbers (SYN) message is sent, wherein the source address (Src) of the SYN message is 10.0.0.1:1234, and the destination address (Dst) thereof is 192.168.1.1:80; and the request message is intercepted by a Client Proxy component (the proxy component on the client side).

It should be noted that the Client Proxy component may intercept all requests that access a Service Cluster IP network segment through an Extended Berkeley Packet Filter (ebpf) program mounted to a network interface. Of course, an Iptables filter tool and the like may also be used, which will not be limited here in the present disclosure.

Exemplarily, in response to that the first connection tracking record corresponding to the address of the Client Pod and the address of the Service is not matched, it indicates that the Client Pod sends the request message to the Service for the first time, and the first message may be encapsulated using the tunnel protocol and then forwarded to the LoadBalancer through the tunnel.

Exemplarily, in step 2 as shown in FIG. 5, the source address of the first encapsulated message is 10.0.0.1:4789 (the address of the Client Proxy), and the destination address thereof is 10.0.20.3:4789 (the address of the LoadBalancer); and Inner-Src and Inner-Dst represent the source address and the destination address of the encapsulated first message.

Exemplarily, the LoadBalancer receives the first encapsulated message and then decapsulate it to acquire the first message. The LoadBalancer, based on the service configuration information issued by the API Server and stored locally, allocates a container in the destination service as the destination container according to the destination address in the first message, and encapsulates the address of the destination container into the Option (a parameter field) of the message and forwards it to the Proxy component on the destination container side through the tunnel.

Exemplarily, with continued reference to step 3 of FIG. 5, the LoadBalancer, based on the request message, allocates the corresponding Endpoint Pod according to the service configuration information stored locally, encapsulates the address 10.0.10.2:8080 of the Endpoint Pod into the Option of the message (e.g., Svr-rs in step 3) through the tunnel protocol to acquire the second encapsulated message SYN, and forwards the second encapsulated message SYN to the Proxy component on the Endpoint side (i.e., the Service). The source address of the second encapsulated message SYN is the address 10.0.20.3:4789 of the LoadBalancer, and the destination address thereof is the address 10.0.10.2:4789 of the Proxy component on the Endpoint side. Thus, dynamic message distribution is achieved by the centralized load balancing component.

Exemplarily, with continued reference to FIG. 5, the Proxy component on the Endpoint side receives the second encapsulated message forwarded by the LoadBalancer and then decapsulates it to acquire the first message, and extracts 10.0.10:8080 recorded in the Option. In step 4, the Proxy component on the Endpoint side performs destination address translation to replace the destination address 192.168.1.1:80 of the first message with 10.0.10.2:8080, and then submits the first message to a network protocol stack of the Endpoint Pod.

It should be understood that because the Pod corresponding to the Service may change, the Pod on the Service side does not need to perceive the Service.

In a possible implementation, the load balancing method further includes: after acquiring the first response message and the address of the destination container, generating, by the proxy component on the destination container side, a second connection tracking record of a communication between the source container and the destination container based on the address of the source container, the address of the destination service, and the address of the destination container; the second connection tracking record is configured to indicate the address of the destination service corresponding to the first response message, such that the proxy component on the destination container side encapsulates the first response message and the address of the destination service using a tunnel, and then sends the first response message and the address of the destination service to the proxy component on the client side.

Exemplarily, with continued reference to FIG. 5, the Proxy component on the Endpoint side extracts 10.0.10:8080 recorded in the Option of the message and then generates the second connection tracking record “(10.0.0.10.2:8080->10.0.0.1:1234): 192.168.1.1:80”, indicating that the address of the Service corresponding to 10.0.0.10.2:8080 to 10.0.0.1:1234 is 192.168.1.1:80, and writes the second connection tracking record to an ebpf map. A record type of the connection tracking record is a response message for accessing the Endpoint Pod (the destination container).

In a possible implementation, the load balancing method further includes: generating and sending, by the destination container, a first response message for the first message that is acquired after the replacement, the first response message carries the address of the source container and the address of the destination container; intercepting the first response message and matching the addresses of the source container and the destination container with existing second connection tracking records, by the proxy component on the destination container side; in response to that a target second connection tracking record corresponding to the addresses of the source container and the destination service is matched, encapsulating an address of a destination service in the target second connection tracking record and the first response message using the tunnel to acquire a third encapsulated message, and sending the third encapsulated message to the proxy component on the client side, a destination address of the third encapsulated message is an address of the proxy component on the client side. For example, the receiving, by the proxy component on the client side, the first response message includes: receiving, by the proxy component on the client side, the third encapsulated message, and decapsulating the third encapsulated message to acquire the address of the destination service and the first response message. The load balancing method further includes: replacing, by the proxy component on the client side, the address of the destination container in the first response message with the address of the destination service, and sending the first response message that is acquired after the replacement to the source container.

Exemplarily, the Endpoint Pod sends the first response message. The Proxy component on the Endpoint side, based on the first response message, matches the target second connection tracking record among the existing second connection tracking records. The Proxy component on the Endpoint side encapsulates the recorded address of the destination service into the Option of a tunnel message according to the tunnel protocol to acquire the third encapsulated message.

Exemplarily, with continued reference to FIG. 5, in step 5, the Endpoint Pod sends the first response message SYN-ACK (Acknowledgment), the source address and the destination address of which are 10.0.10.2:8080 and 10.0.10.1:1234, respectively. In step 6, the Proxy component on the Endpoint side may intercept the SYN-ACK through the ebpf program mounted to the network interface, and matches “(10.0.0.10.2:8080->10.0.0.1:1234): 192.168.1.1:80”, thereby acquiring the address 192.168.1.1:80 of the corresponding response end. The Proxy component on the Endpoint side encapsulates the recorded 192.168.1.1:80 into the Option of the tunnel message according to the tunnel protocol to acquire the third encapsulated message, and sends the third encapsulated message through the tunnel to the Client Proxy component which corresponds to 10.0.10.1:1234.

Exemplarily, in step 6 as shown in FIG. 5, the Client Proxy component receives and decapsulates the Proxy traffic in the tunnel, i.e., the third encapsulated message, to extract the Service address Svc:192.168.1.1:80 recorded in the Option of the tunnel message, and replaces the source address of the first response message with the Service address 192.168.1.1:80 recorded in the Option to acquire the SYN-ACK after the replacement in step 7, and submits the SYN-ACK after the replacement to a network protocol stack of the Client Pod.

It should be understood that because the Pod corresponding to the Service may change, the Pod on the Client side needs to know the Service in communication, but does not need to perceive the corresponding particular Pod on the Service side.

Exemplarily, in step 6 as shown in FIG. 5, the service address Svc:192.168.1.1:80 recorded in the Option of the tunnel message is extracted; the first connection tracking record “(10.0.0.1:1234->192.168.1.1:80):10.0.0.10.2:8080” is generated, which indicates the address of the destination container corresponding to 10.0.10.1:1234 to 192.168.1.1:80 is 10.0.10.2:8080, and written to the ebpf map.

In a possible implementation, the load balancing method further includes: generating and sending, by the destination container, a handshake message according to the first response message that is acquired after the replacement, the handshake message carries the address of the source container and the address of the destination container; intercepting, by the proxy component on the client side, the handshake message, matching the addresses of the source container and the destination service with the existing first connection tracking records, and acquiring the address of the destination container that matches with the addresses of the source container and the destination service, then translating a destination address of the handshake message to the address of the destination container, and sending the handshake message to the destination container.

Exemplarily, in step 8 as shown in FIG. 5, the Client Pod replies an ACK handshake message. The source address of the handshake message is 10.0.10.1:1234 (the address of the source container), and the destination address thereof is 192.168.1.1:80 (the address of the destination service). The Client Proxy component may intercept the handshake message through the ebpf program mounted to the network interface, and may match “(10.0.0.1:1234->192.168.1.1:80):10.0.0.10.2:8080” recorded in step 6 to acquire the corresponding destination container address 10.0.10.2:8080, and the destination address 192.168.1.1:80 of the handshake message is replaced with 10.0.10.2:8080, i.e., the corresponding ACK in step 9. The handshake message is then directly sent to the Endpoint Pod according to 10.0.10.2:8080, thereby completing TCP's three-time handshaking.

Correspondingly, for the Client Pod subsequently sending the message of accessing the Service IP, a reference may be made to the process of steps 8 and 9 as shown in FIG. 5. The Client Proxy component intercepts the message and matches the corresponding connection tracking record. Then, network address translation is performed. That is, the destination address of the original message is replaced with the address of the Endpoint Pod corresponding to the connection tracking record, and the message is directly sent to the Endpoint Pod.

It should be noted that destination address translation is realized by the Proxy component on the Client side, so that the traffic direct communication between the source end Pod and the destination end Pod can be directly performed with no use of the LoadBalancer. The forwarding pressure of the LoadBalancer is reduced, the communication link is shortened, and the advantages of high throughput and low delay are achieved.

With the above-mentioned method, the Service traffic communication is performed between a node and the LoadBalancer based on the ebpf technology according to the tunnel protocol; dynamic distribution of the Service traffic is realized; and on the basis of almost not increasing additional network delay, the data volume required by distributing the Service configuration information is greatly reduced so as to reduce the load pressure of the API Server. Moreover, because the LoadBalancer only processes the first message and the subsequent traffic is of direct communication between Pods, the forwarding pressure is low, and the advantages of high throughput and low delay are achieved.

It should be understood that because the Endpoint Pod might be deleted, in this case, the Client Proxy component may send a message to the LoadBalancer to allocate a new Endpoint Pod, and the TCP three-time handshaking process is carried out again.

The embodiments of a message processing flow of the LoadBalancer and a message processing flow of the Proxy component are described below with reference to the drawings.

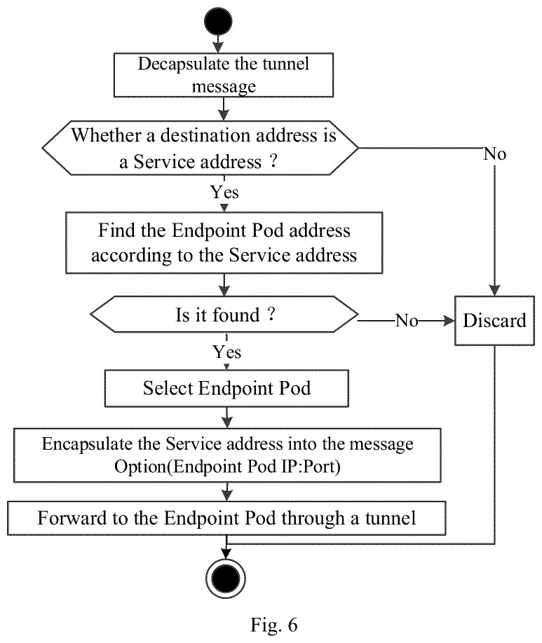

Exemplarily, as shown in FIG. 6, the LoadBalancer decapsulate the tunnel message, and determines whether a destination address of the message is a Service address. If it is, search for a corresponding Endpoint Pod address according to the Service address; otherwise, discard the message. Further, if the corresponding Endpoint Pod address is found, select one of Endpoint Pods, and then encapsulate the Service address into the message and forward to the Endpoint Pod through a tunnel; if the corresponding Endpoint Pod address is not found, discard the message.

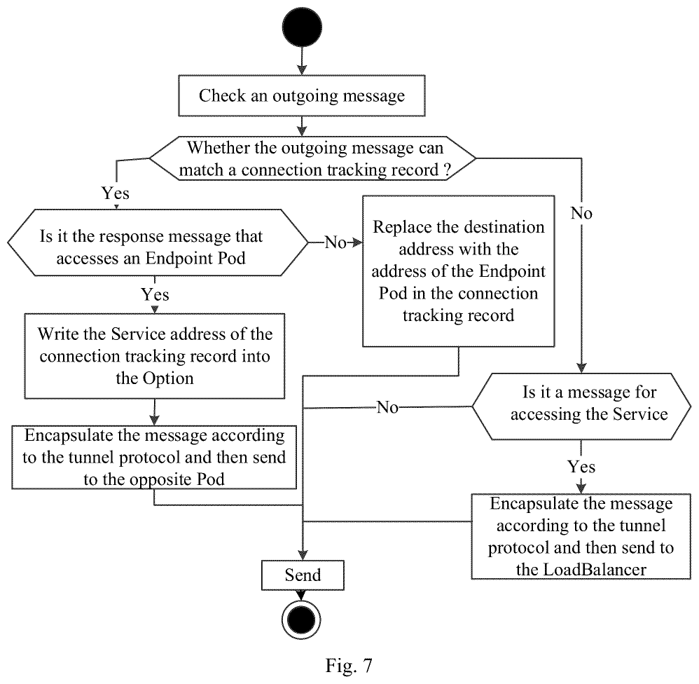

Exemplarily, the Proxy component of a node, according to an actual application scenario, may service as the Proxy component on the Client side, or may serve as the Proxy component on the Service side. With reference to FIG. 7, when processing an outgoing message, the Proxy component may firstly check whether the outgoing message can match a connection tracking record. If the outgoing message can match a connection tracking record and the outgoing message is the response message that accesses an Endpoint Pod, write the Service address of the connection tracking record into the Option according to the tunnel protocol, and then send to an opposite end Pod, i.e., the Client Pod. If the outgoing message can match a connection tracking record but the outgoing message isn't the response message that accesses an Endpoint Pod, the Proxy component performs destination address translation to replace the destination address with the address of the Endpoint Pod in the connection tracking record, and then the message can be directly sent to the corresponding Endpoint Pod. If the outgoing message cannot match a connection tracking record, determine whether the message is a message for accessing the Service, if it is, encapsulate the message according to the tunnel protocol and then send to the LoadBalancer; otherwise, send the message directly.

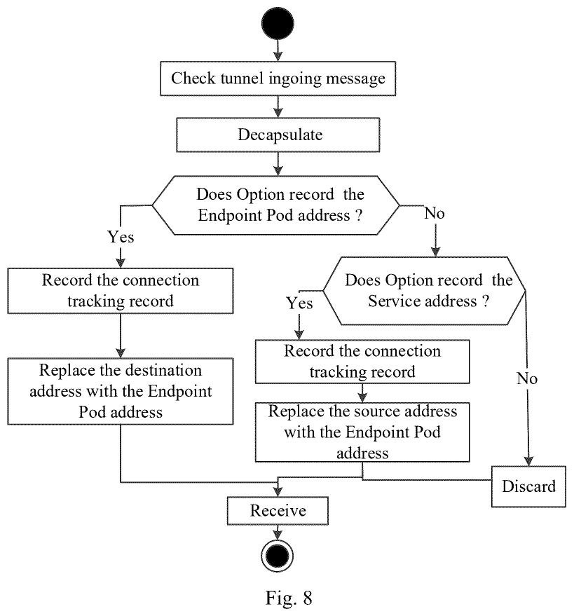

Exemplarily, with reference to FIG. 8, the Proxy component processes an ingoing message that is sent to a node through a tunnel. After a tunnel message is received, decapsulate the tunnel message, and determine whether an Endpoint Pod address or a Service address is recorded in the Option, and then a corresponding connection tracking record is recorded. If the Endpoint Pod address is recorded, perform a destination address translation. If the Service address is recorded, perform a source address translation. The message acquired after the translation is then submitted to a Pod network protocol stack, such that a corresponding Pod receives the message.

With the above-mentioned method, the LoadBalancer is responsible for perceiving the correspondence between a Service and an Endpoint in the API Server and recording it in a local data plane configuration, i.e., the service configuration information, and encapsulating a content into a tunnel while performing load sharing on a first message that accesses the Service. The Proxy component performs operations such as address translation according to the information encapsulated in the message. Because the LoadBalancer only processes the first message and the subsequent traffic is of direct communication between Pods, the forwarding pressure is low, and the advantages of high throughput and low delay are achieved.

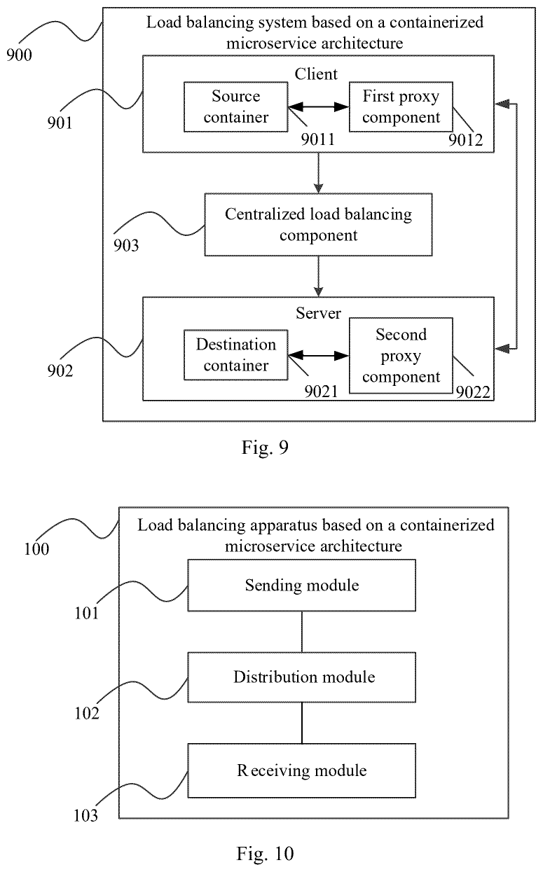

Based on the same inventive concept, the present disclosure provides a load balancing system based on a containerized microservice architecture. With reference to FIG. 9, the load balancing system 900 based on a containerized microservice architecture includes a client 901, a server 902, and a centralized load balancing component 903. The client 901 includes a source container 9011 of the client and a first proxy component 9012 on the client side. The server 902 includes a destination container 9021 of the server and a second proxy component 9022 on the server side.

For the interaction process of the components of the load balancing system based on a containerized microservice architecture, a reference may be made to the above method embodiments. The proxy component on the server side is the above-mentioned proxy component on the destination container side, which will not be described redundantly here.

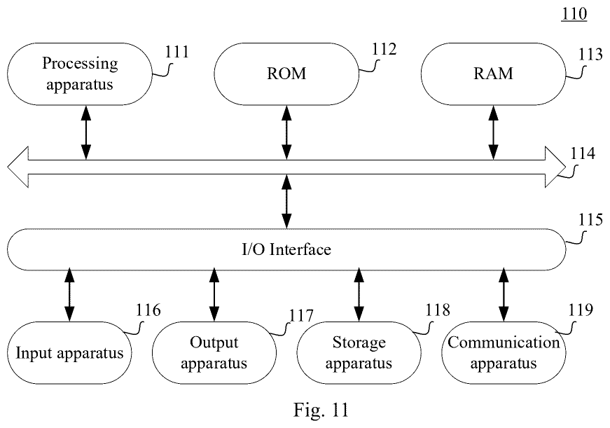

Based on the same inventive concept, an embodiment of the present disclosure provides a load balancing apparatus based on a containerized microservice architecture. With reference to FIG. 10, the load balancing apparatus 100 based on a containerized microservice architecture includes:
a sending module 101, configured to intercept, by a proxy component deployed on a client side, a first message initiated by a source container of the client that accesses a destination service in a microservice cluster, encapsulate the first message using the tunnel, and then send the first message to the centralized load balancing component, the centralized load balancing component is configured to distribute a first message for each container of the client that accesses each service in the microservice cluster, and forward the first message to a destination container of a destination service through a tunnel;
a distribution module 102, configured to distribute, by the centralized load balancing component, the first message to a destination container of the destination service such that the destination container generates a first response message for the first message; and
a receiving module 103, configured to receive, by the proxy component on the client side, the first response message, and generate a first connection tracking record of a communication between the source container and the destination container based on the first response message, wherein the first connection tracking record is configured to record a network address translation relationship between the source container and the destination container, such that a traffic direct communication is performed through the tunnel between the source container and the destination container based on the network address translation relationship after a connection of the first message is established.

Optionally, the sending module 101 is configured to:
intercept, by the proxy component deployed on the client side, a request message initiated by the source container of the client that accesses the destination service in the microservice cluster, and match addresses of the source container and the destination service with existing first connection tracking records; and
in response to that a first connection tracking record corresponding to the addresses of the source container and the destination service is not matched, determine the request message as the first message, encapsulate the first message using the tunnel, and then send the first message to the centralized load balancing component.

The load balancing apparatus 100 based on a containerized microservice architecture further includes:
a translation module, configured to, in response to that a target first connection tracking record corresponding to the addresses of the source container and the destination service is matched, translate a destination address of the request message to an address of a destination container in the target first connection tracking record, and send the request message to the destination container.

Optionally, the distribution module 102 is configured to:
determine, by the centralized load balancing component, the destination container of the destination service corresponding to the first message according to service configuration information, and distribute the first message to the destination container, wherein the service configuration information is issued by the microservice cluster to indicate a configuration rule for the centralized load balancing component distributing a message.

Optionally, the first response message carries an address of the source container, an address of the destination service, and an address of the destination container; and the receiving module 103 is configured to:
generate a first connection tracking record of a communication between the source container and the destination container based on the address of the source container, the address of the destination service, and the address of the destination container;
wherein a first connection tracking record is configured to instruct that a destination address of a request message initiated by the source container that accesses the destination service is changed from the address of the destination service to the address of the destination container, and instruct that a source address of a response message returned by the destination container to the source container is changed from the address of the destination container to the address of the destination service.

Optionally, the first message carries the address of the source container and the address of the destination service; and the sending module 101 is configured to:
encapsulating, by the proxy component on the client side, the first message using a tunnel to acquire a first encapsulated message, and send the first encapsulated message to the centralized load balancing component, wherein a destination address of the first encapsulated message is an address of the centralized load balancing component.

The distribution module 102 is configured to:
decapsulate, by the centralized load balancing component, the first encapsulated message to acquire the first message, encapsulate the address of the destination container and the first message using the tunnel to acquire a second encapsulated message, and distribute the second encapsulated message to a proxy component on the destination container side, wherein a destination address of the second encapsulated message is an address of the proxy component on the destination container side;
decapsulate, by the proxy component on the destination container side, the second encapsulated message to acquire the first message and the address of the destination container, replace the address of the destination service in the first message with the address of the destination container, and then send the first message acquired after the replacement to the destination container.

The load balancing apparatus 100 based on a containerized microservice architecture further includes a generation module, and the generation module is configured to:
after acquiring the first message and the address of the destination container, generate, by the proxy component on the destination container side, a second connection tracking record of communication between the source container and the destination container based on the address of the source container, the address of the destination service, and the address of the destination container;
wherein the second connection tracking record is configured to indicate the address of the destination service corresponding to the first response message, such that the proxy component on the destination container side encapsulates the first response message and the address of the destination service using a tunnel, and then sends the first response message and the address of the destination service to the proxy component on the client side.

The load balancing apparatus 100 based on a containerized microservice architecture further includes a response module, and the response module is configured to:
generate and send, by the destination container, a first response message for the first message acquired after the replacement, wherein the first response message carries the address of the source container and the address of the destination container;
intercept, by the proxy component on the destination container side, the first response message; match the addresses of the source container and the destination container with existing second connection tracking records; in response to that a target second connection tracking record corresponding to the addresses of the source container and the destination service is matched, encapsulate an address of a destination service in the target second connection tracking record and the first response message using a tunnel to acquire a third encapsulated message, and send the third encapsulated message to the proxy component on the client side, wherein a destination address of the third encapsulated message is an address of the proxy component on the client side.

The receiving module 103 is configured to:
receive, by the proxy component on the client side, the third encapsulated message, and decapsulate the third encapsulated message to acquire the address of the destination service and the first response message.

The load balancing apparatus 100 based on a containerized microservice architecture further includes a replacement module, the replacement module is configured to:
replace, by the proxy component on the client side, the address of the destination container in the first response message with the address of the destination service, and send the first response message acquired after the replacement to the source container.

Based on the same concept, an embodiment of the present disclosure further provides a non-transitory computer-readable storage medium, storing a computer program thereon, and the computer program, when executed by a processing apparatus, implements the load balancing method based on the containerized microservice architecture described in any one of the above-mentioned embodiments.

Based on the same inventive concept, an embodiment of the present disclosure further provides an electronic device, which includes:
a storage apparatus, storing a computer program; and
a processing apparatus, configured to execute the computer program in the storage apparatus to implement the load balancing method based on the containerized microservice architecture described in any one of the above-mentioned embodiments.

Based on the same concept, an embodiment of the present disclosure further provides a computer program product, including a computer program which, when executed by a processor, implements the load balancing method based on the containerized microservice architecture described in any one of the above-mentioned embodiments.

Next, with reference to FIG. 11, there is shown a structural schematic diagram of an electronic device 110 adapted to implement the embodiments of the present disclosure. The terminal device in the embodiment of the present disclosure may include but not be limited to mobile terminals such as a mobile phone, a notebook computer, a digital broadcasting receiver, a personal digital assistant (PDA), a portable Android device (PAD), a portable media player (PMP), and a vehicle-mounted terminal (e.g., a vehicle-mounted navigation terminal), and fixed terminals such as a digital TV and a desktop computer. The electronic device shown in FIG. 11 is merely an example, and should not pose any limitation to the functions and the range of use of the embodiments of the present disclosure.

As shown in FIG. 11, the electronic device 110 may include a processing apparatus (e.g., a central processing unit, or a graphics processing unit) 111, which can perform various suitable actions and processing according to a program stored on a read-only memory (ROM) 112 or a program loaded from a storage apparatus 118 into a random access memory (RAM) 113. The RAM 113 further stores various programs and data required for operations of the electronic device 110. The processing apparatus 111, the ROM 112, and the RAM 113 are interconnected by means of a bus 114. An input/output (I/O) interface 115 is also connected to the bus 114.

Usually, the following apparatuses may be connected to the I/O interface 115: an input apparatus 116 including, for example, a touchscreen, a touchpad, a keyboard, a mouse, a camera, a microphone, an accelerometer, and a gyroscope; an output apparatus 117 including, for example, a liquid crystal display (LCD), a loudspeaker, and a vibrator; a storage apparatus 118 including, for example, a magnetic tape and a hard disk; and a communication apparatus 119. The communication apparatus 119 may allow the electronic device 110 to be in wireless or wired communication with other devices to exchange data. While FIG. 11 illustrates the electronic device 110 having various apparatuses, it is to be understood that all the illustrated apparatuses are not necessarily implemented or included. More or less apparatuses may be implemented or included alternatively.

Particularly, according to the embodiments of the present disclosure, the process described above with reference to the flowchart may be implemented as a computer software program. For example, an embodiment of the present disclosure includes a computer program product, which includes a computer program carried by a non-transitory computer-readable medium. The computer program includes a program code for performing the method shown in the flowchart. In such an embodiment, the computer program may be downloaded online through the communication apparatus 119 and installed, or installed from the storage apparatus 118, or installed from the ROM 112. When the computer program is executed by the processing apparatus 111, the functions defined in the method of the embodiments of the present disclosure are executed.

It should be noted that the computer-readable medium described above in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination of them. More specific examples of the computer-readable storage medium may include, but be not limited, to an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any appropriate combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal that propagates in a baseband or as a part of a carrier and carries thereon a computer-readable program code. The data signal propagating in such a manner may take a plurality of forms, including, but not limited to, an electromagnetic signal, an optical signal, or any appropriate combination thereof. The computer-readable signal medium may also be any other computer-readable medium than the computer-readable storage medium. The computer-readable storage medium may send, propagate or transmit a program used by or in combination with an instruction execution system, apparatus or device. The program code included on the computer-readable medium may be transmitted by using any suitable medium, including, but not limited to, an electric wire, a fiber-optic cable, radio frequency (RF) and the like, or any appropriate combination thereof.

In some implementations, any network protocol currently known or to be developed in future such as HyperText Transfer Protocol (HTTP) may be utilized for communication, and communication and interconnection with digital data (e.g., a communication network) in any form or of any medium may be achieved. Examples of the communication network include a local area network (LAN), a wide area network (WAN), an Internet work (e.g., the Internet), a peer-to-peer network (e.g., ad hoc peer-to-peer network), and any network currently known or to be developed in future.

The above-mentioned computer-readable medium may be included in the electronic device described above, or may exist alone without being assembled with the electronic device.

The above-mentioned computer-readable medium carries one or more programs which, when executed by the electronic device, cause the electronic device to: intercept, by a proxy component deployed on a client side, a first message initiated by a source container of the client that accesses a destination service in a microservice cluster, encapsulate the first message using the tunnel, and then send the first message to the centralized load balancing component, wherein the centralized load balancing component is configured to distribute a first message for each container of the client that accesses each service in the microservice cluster, and forward the message to a destination container of a destination service through a tunnel; distribute, by the centralized load balancing component, the first message to a destination container of the destination service such that the destination container generates a first response message for the first message; and receive, by the proxy component on the client side, the first response message, and generate a first connection tracking record of communication between the source container and the destination container based on the first response message, wherein the first connection tracking record is configured to record a network address translation relationship between the source container and the destination container such that a traffic direct communication is performed between the source container and the destination container based on the network address translation relationship after a connection of the first message is established.

A computer program code for performing the operations in the present disclosure may be written in one or more programming languages or a combination thereof. The programming languages include, but are not limited to, object oriented programming languages, such as Java, Smalltalk, and C++, and conventional procedural programming languages, such as C or similar programming languages. The program code can be executed fully on a user's computer, executed partially on a user's computer, executed as an independent software package, executed partially on a user's computer and partially on a remote computer, or executed fully on a remote computer or a server. In a circumstance in which a remote computer is involved, the remote computer may connect to a user computer over any type of network, including a local area network (LAN) or a wide area network (WAN), or may connect to an external computer (e.g., over the Internet by using an Internet service provider).

The flowcharts and block diagrams in the accompanying drawings illustrate system architectures, functions and operations that may be implemented by the system, method and computer program product according to the embodiments of the present disclosure. In this regard, each block in the flowcharts or block diagrams may represent a module, a program segment or a part of code, and the module, the program segment or the part of code includes one or more executable instructions for implementing specified logic functions. It should also be noted that, in some alternative implementations, the functions marked in the blocks may alternatively be carried out in an order different from that marked in the drawings. For example, two successively shown blocks actually may be executed in parallel substantially, or may be executed in reverse order sometimes, depending on the functions involved. It should also be noted that each block in the flowcharts and/or block diagrams and combinations of the blocks in the flowcharts and/or block diagrams may be implemented by a dedicated hardware-based system for executing specified functions or operations, or may be implemented by a combination of dedicated hardware and computer instructions.

The modules described in the embodiments of the present disclosure may be implemented in a form of software or in a form of hardware. The name of a module does not constitute a limitation on the module itself.

The functions described above herein may be performed at least in part by one or more hardware logic components. For example, exemplary types of hardware logic components that can be used without limitations include a field programmable gate array (FPGA), an application specific integrated circuit (ASIC), an application specific standard product (ASSP), a system on chip (SOC), a complex programmable logic device (CPLD), and the like.

In the context of the present disclosure, a machine-readable medium may be a tangible medium that may include or store a program for use by or in combination with an instruction execution system, apparatus or device. The machine-readable medium may be a machine-readable signal medium or a machine-readable storage medium. The machine-readable medium may include, but be not limited to, an electronic, magnetic, optical, electromagnetic, infrared, or semiconductor system, apparatus or device, or any appropriate combination thereof. More specific examples of the machine-readable storage medium include: an electrical connection with one or more wires, a portable computer disk, a hard disk, a random access memory (RAM), a read-only memory (ROM), an erasable programmable ROM (an EPROM or a flash memory), an optical fiber, a portable compact disc read-only memory (CD-ROM), an optical storage device, a magnetic storage device, or any suitable combination thereof.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, although several specific implementation details are included in the above discussion, these specific implementation details should not be interpreted as limiting the scope of the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. On the contrary, the specific features and actions described above are only exemplary forms of implementing the claims. Specific manners of operations performed by the modules in the apparatus in the above embodiment have been described in detail in the embodiments regarding the method, which will not be explained and described in detail herein again.

1. A load balancing method based on a containerized microservice architecture, the load balancing method comprising:
intercepting, by a proxy component deployed on a client side, a first message initiated by a source container of a client that accesses a destination service in a microservice cluster, encapsulating the first message using a tunnel, and then sending the first message to a centralized load balancing component, wherein the centralized load balancing component is configured to distribute a first message for each container of the client that accesses each service in the microservice cluster, and forward the message to a destination container of a destination service through the tunnel;
distributing, by the centralized load balancing component, the first message to a destination container of the destination service such that the destination container generates a first response message for the first message; and
receiving, by the proxy component on the client side, the first response message, and generating a first connection tracking record of a communication between the source container and the destination container based on the first response message, wherein the first connection tracking record is configured to record a network address translation relationship between the source container and the destination container such that a traffic direct communication is performed between the source container and the destination container based on the network address translation relationship after a connection of the first message is established.

2. The load balancing method based on a containerized microservice architecture according to claim 1, wherein the intercepting, by a proxy component deployed on a client side, a first message initiated by a source container of a client that accesses a destination service in a microservice cluster, encapsulating the first message using a tunnel, and then sending the first message to a centralized load balancing component comprises:
intercepting, by the proxy component deployed on the client side, a request message initiated by the source container of the client that accesses the destination service in the microservice cluster, and matching addresses of the source container and the destination service with existing first connection tracking records; and
in response to that the first connection tracking record corresponding to the addresses of the source container and the destination service is not matched, determining the request message as the first message, encapsulating the first message using the tunnel, and then sending the first message to the centralized load balancing component.

3. The load balancing method based on a containerized microservice architecture according to claim 2, further comprising:
in response to that a target first connection tracking record corresponding to the addresses of the source container and the destination service is matched, translating a destination address of the request message to an address of the destination container in the target first connection tracking record, and sending the request message to the destination container.

4. The load balancing method based on a containerized microservice architecture according to claim 1, wherein the distributing, by the centralized load balancing component, the first message to a destination container of the destination service comprises:
determining, by the centralized load balancing component, the destination container of the destination service corresponding to the first message according to service configuration information, and distributing the first message to the destination container, wherein the service configuration information is issued by the microservice cluster to indicate a configuration rule for the centralized load balancing component distributing a message.

5. The load balancing method based on a containerized microservice architecture according to claim 1, wherein the first response message carries an address of the source container, an address of the destination service, and an address of the destination container; and the generating a first connection tracking record of a communication between the source container and the destination container based on the first response message comprises:
generating the first connection tracking record of the communication between the source container and the destination container based on the address of the source container, the address of the destination service, and the address of the destination container;
wherein the first connection tracking record is configured to instruct that a destination address of a request message initiated by the source container that accesses the destination service is changed from the address of the destination service to the address of the destination container, and instruct that a source address of a response message returned by the destination container to the source container is changed from the address of the destination container to the address of the destination service.

6. The load balancing method based on a containerized microservice architecture according to claim 1, wherein the first message carries an address of the source container and an address of the destination service; the encapsulating the first message using a tunnel and then sending the first message to a centralized load balancing component comprises:
encapsulating, by the proxy component on the client side, the first message using a tunnel to acquire a first encapsulated message, and sending the first encapsulated message to the centralized load balancing component, wherein a destination address of the first encapsulated message is an address of the centralized load balancing component; and
the distributing, by the centralized load balancing component, the first message to a destination container of the destination service comprises:
decapsulating, by the centralized load balancing component, the first encapsulated message to acquire the first message, encapsulating the address of the destination container and the first message using a tunnel to acquire a second encapsulated message, and distributing the second encapsulated message to a proxy component of the destination container side, wherein a destination address of the second encapsulated message is an address of the proxy component on the destination container side;
decapsulating, by the proxy component on the destination container side, the second encapsulated message to acquire the first message and the address of the destination container, and after replacing the address of the destination service in the first message with the address of the destination container, sending the first message acquired after the replacement to the destination container.

7. The load balancing method based on a containerized microservice architecture according to claim 6, further comprising:
after acquiring the first message and the address of the destination container, generating, by the proxy component on the destination container side, a second connection tracking record of a communication between the source container and the destination container based on the address of the source container, the address of the destination service, and the address of the destination container;
wherein the second connection tracking record is configured to indicate the address of the destination service corresponding to the first response message such that the proxy component of the destination container side encapsulate the first response message and the address of the destination service using a tunnel and then sends the first response message and the address of the destination service to the proxy component on the client side.

8. The load balancing method based on a containerized microservice architecture according to claim 7, further comprising:
generating and sending, by the destination container, a first response message for the first message acquired after the replacement, wherein the first response message carries the address of the source container and the address of the destination container;
intercepting, by the proxy component on the destination container side, the first response message; matching the addresses of the source container and the destination container with existing second connection tracking records; in response to that a target second connection tracking record corresponding to the addresses of the source container and the destination service is matched, encapsulating an address of a destination service in the target second connection tracking record and the first response message using a tunnel to acquire a third encapsulated message, and sending the third encapsulated message to the proxy component on the client side, wherein a destination address of the third encapsulated message is an address of the proxy component on the client side;
the receiving, by the proxy component on the client side, the first response message comprises:
receiving, by the proxy component on the client side, the third encapsulated message, and decapsulating the third encapsulated message to acquire the address of the destination service and the first response message; and
the load balancing method further comprises:
replacing, by the proxy component on the client side, the address of the destination container in the first response message with the address of the destination service, and sending the first response message acquired after the replacement to the source container.

9. A non-transitory computer-readable storage medium, storing a computer program which, when executed by a processing apparatus, implements a load balancing method based on a containerized microservice architecture, the load balancing method comprising:
intercepting, by a proxy component deployed on a client side, a first message initiated by a source container of a client that accesses a destination service in a microservice cluster, encapsulating the first message using a tunnel, and then sending the first message to a centralized load balancing component, wherein the centralized load balancing component is configured to distribute a first message for each container of the client that accesses each service in the microservice cluster, and forward the message to a destination container of a destination service through the tunnel;
distributing, by the centralized load balancing component, the first message to a destination container of the destination service such that the destination container generates a first response message for the first message; and
receiving, by the proxy component on the client side, the first response message, and generating a first connection tracking record of a communication between the source container and the destination container based on the first response message, wherein the first connection tracking record is configured to record a network address translation relationship between the source container and the destination container such that a traffic direct communication is performed between the source container and the destination container based on the network address translation relationship after a connection of the first message is established.

10. The non-transitory computer-readable storage medium according to claim 9, wherein the intercepting, by a proxy component deployed on a client side, a first message initiated by a source container of a client that accesses a destination service in a microservice cluster, encapsulating the first message using a tunnel, and then sending the first message to a centralized load balancing component comprises:
intercepting, by the proxy component deployed on the client side, a request message initiated by the source container of the client that accesses the destination service in the microservice cluster, and matching addresses of the source container and the destination service with existing first connection tracking records; and
in response to that the first connection tracking record corresponding to the addresses of the source container and the destination service is not matched, determining the request message as the first message, encapsulating the first message using the tunnel, and then sending the first message to the centralized load balancing component.

11. The non-transitory computer-readable storage medium according to claim 10, wherein the method further comprises:
in response to that a target first connection tracking record corresponding to the addresses of the source container and the destination service is matched, translating a destination address of the request message to an address of the destination container in the target first connection tracking record, and sending the request message to the destination container.

12. The non-transitory computer-readable storage medium according to claim 9, wherein the distributing, by the centralized load balancing component, the first message to a destination container of the destination service comprises:
determining, by the centralized load balancing component, the destination container of the destination service corresponding to the first message according to service configuration information, and distributing the first message to the destination container, wherein the service configuration information is issued by the microservice cluster to indicate a configuration rule for the centralized load balancing component distributing a message.

13. The non-transitory computer-readable storage medium according to claim 9, wherein the first response message carries an address of the source container, an address of the destination service, and an address of the destination container; and the generating a first connection tracking record of a communication between the source container and the destination container based on the first response message comprises:
generating the first connection tracking record of the communication between the source container and the destination container based on the address of the source container, the address of the destination service, and the address of the destination container;
wherein the first connection tracking record is configured to instruct that a destination address of a request message initiated by the source container that accesses the destination service is changed from the address of the destination service to the address of the destination container, and instruct that a source address of a response message returned by the destination container to the source container is changed from the address of the destination container to the address of the destination service.

14. The non-transitory computer-readable storage medium according to claim 9, wherein the first message carries an address of the source container and an address of the destination service; the encapsulating the first message using a tunnel and then sending the first message to a centralized load balancing component comprises:
encapsulating, by the proxy component on the client side, the first message using a tunnel to acquire a first encapsulated message, and sending the first encapsulated message to the centralized load balancing component, wherein a destination address of the first encapsulated message is an address of the centralized load balancing component; and
the distributing, by the centralized load balancing component, the first message to a destination container of the destination service comprises:
decapsulating, by the centralized load balancing component, the first encapsulated message to acquire the first message, encapsulating the address of the destination container and the first message using a tunnel to acquire a second encapsulated message, and distributing the second encapsulated message to a proxy component of the destination container side, wherein a destination address of the second encapsulated message is an address of the proxy component on the destination container side;
decapsulating, by the proxy component on the destination container side, the second encapsulated message to acquire the first message and the address of the destination container, and after replacing the address of the destination service in the first message with the address of the destination container, sending the first message acquired after the replacement to the destination container.

15. The non-transitory computer-readable storage medium according to claim 14, wherein the method further comprises:
after acquiring the first message and the address of the destination container, generating, by the proxy component on the destination container side, a second connection tracking record of a communication between the source container and the destination container based on the address of the source container, the address of the destination service, and the address of the destination container;
wherein the second connection tracking record is configured to indicate the address of the destination service corresponding to the first response message such that the proxy component of the destination container side encapsulate the first response message and the address of the destination service using a tunnel and then sends the first response message and the address of the destination service to the proxy component on the client side.

16. The non-transitory computer-readable storage medium according to claim 15, wherein the method further comprises:
generating and sending, by the destination container, a first response message for the first message acquired after the replacement, wherein the first response message carries the address of the source container and the address of the destination container;
intercepting, by the proxy component on the destination container side, the first response message; matching the addresses of the source container and the destination container with existing second connection tracking records; in response to that a target second connection tracking record corresponding to the addresses of the source container and the destination service is matched, encapsulating an address of a destination service in the target second connection tracking record and the first response message using a tunnel to acquire a third encapsulated message, and sending the third encapsulated message to the proxy component on the client side, wherein a destination address of the third encapsulated message is an address of the proxy component on the client side;
the receiving, by the proxy component on the client side, the first response message comprises:
receiving, by the proxy component on the client side, the third encapsulated message, and decapsulating the third encapsulated message to acquire the address of the destination service and the first response message; and
the load balancing method further comprises:
replacing, by the proxy component on the client side, the address of the destination container in the first response message with the address of the destination service, and sending the first response message acquired after the replacement to the source container.

17. An electronic device, comprising:
a storage apparatus, configured to store a computer program; and
a processing apparatus, configured to execute the computer program in the storage apparatus to implement a load balancing method based on a containerized microservice architecture, the load balancing method comprising:
intercepting, by a proxy component deployed on a client side, a first message initiated by a source container of a client that accesses a destination service in a microservice cluster, encapsulating the first message using a tunnel, and then sending the first message to a centralized load balancing component, wherein the centralized load balancing component is configured to distribute a first message for each container of the client that accesses each service in the microservice cluster, and forward the message to a destination container of a destination service through the tunnel;
distributing, by the centralized load balancing component, the first message to a destination container of the destination service such that the destination container generates a first response message for the first message; and
receiving, by the proxy component on the client side, the first response message, and generating a first connection tracking record of a communication between the source container and the destination container based on the first response message, wherein the first connection tracking record is configured to record a network address translation relationship between the source container and the destination container such that a traffic direct communication is performed between the source container and the destination container based on the network address translation relationship after a connection of the first message is established.

18. The electronic device according to claim 17, wherein the intercepting, by a proxy component deployed on a client side, a first message initiated by a source container of a client that accesses a destination service in a microservice cluster, encapsulating the first message using a tunnel, and then sending the first message to a centralized load balancing component comprises:
intercepting, by the proxy component deployed on the client side, a request message initiated by the source container of the client that accesses the destination service in the microservice cluster, and matching addresses of the source container and the destination service with existing first connection tracking records; and
in response to that the first connection tracking record corresponding to the addresses of the source container and the destination service is not matched, determining the request message as the first message, encapsulating the first message using the tunnel, and then sending the first message to the centralized load balancing component.

19. The electronic device according to claim 18, wherein the method further comprises:
in response to that a target first connection tracking record corresponding to the addresses of the source container and the destination service is matched, translating a destination address of the request message to an address of the destination container in the target first connection tracking record, and sending the request message to the destination container.

20. The electronic device according to claim 17, wherein the distributing, by the centralized load balancing component, the first message to a destination container of the destination service comprises:
determining, by the centralized load balancing component, the destination container of the destination service corresponding to the first message according to service configuration information, and distributing the first message to the destination container, wherein the service configuration information is issued by the microservice cluster to indicate a configuration rule for the centralized load balancing component distributing a message.
